(19) United States
(12) Patent Application Publication
(10) Pub. No.: US 2009/0170510 A1
(43) Pub. Date: Jul. 2, 2009

(54) NEIGHBOR CELL MANAGEMENT METHOD AND APPARATUS FOR A MOBILE TERMINAL

(75) Inventor: Yu Shin KIM, Osan-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/347,104

(22) Filed: Dec. 31, 2008

(30) Foreign Application Priority Data
Jan. 2, 2008 (KR) 10-2008-0000245

(51) Int. Cl. H04W 8/22

(52) U.S. Cl. 455/434

(57) ABSTRACT

A neighbor cell management method and apparatus is provided for adjusting a number of neighbor cells to be managed adaptive to a mobility and electric field status of a mobile terminal. The neighbor cell management method determines a number of cell changes in a first interval as counted by a first timer and determines a received signal strength of a current serving cell, determines a mobility of the mobile terminal and electric field status based on the number of cell changes and received signal strength, and adjusts a number of neighbor cells listed on a neighbor cell list according to the mobility and electric field status.

### PRIORITY

This application claims the benefit under 35 U.S.C. §119(a) of a Korean patent application filed in the Korean Intellectual Property Office on Jan. 2, 2008 and assigned Serial No. 10-2008-0000245, the entire disclosure of which is hereby incorporated by reference.

### BACKGROUND OF THE INVENTION

1. Field of the Invention

The present invention relates to a mobile terminal. More particularly, the present invention relates to a neighbor cell management method and apparatus for a mobile terminal.

2. Description of the Related Art

Mobile communication systems are broadly classified into two categories: synchronous system and asynchronous system. The synchronous system is a communication system in which base stations are synchronized with reference to a global reference time provided by a Global Positioning System (GPS) enabled timekeeping system, and the asynchronous system is a communication system in which the base stations are not required to be synchronized but the mobile terminal is synchronized with its serving base station. Accordingly, in the asynchronous mobile communication system, a synchronization process is required between the mobile terminal and the base station. The Global System for Mobile Communications (GSM) is a 2^{nd} generation asynchronous mobile communication system. In the GSM, each base station transmits a frame containing synchronization information through a Synchronization Channel (SCH).

The GSM uses Time Division Multiple Access (TDMA) frames each grouping eight timeslots giving eight burst periods. The synchronization and other signaling information is transmitted through a control channel, more particularly, a Broadcast Channel (BCH). The BCH carries a Frequency Correction Channel (FCCH), an SCH, and a Broadcast Control Channel (BCCH). A base station receives a Frequency Correction Burst (FCB) through the FCCH and a synchronization burst (SB) through the SCH. A mobile terminal acquires synchronization with the base station with reference to the FCB and SB.

In one case, the mobile terminal, if available, may acquire and maintain synchronizations with 6 neighbor cells listed in a BCCH Allocation (BA) list obtained from the System Information (SI) received from the base station. At this time, the mobile terminal is roughly synchronized with the 6 cells through the FCB and obtains the SI and accurate synchronization information from the SB transmitted by the base station. The reason why the mobile terminal maintains synchronizations with 6 neighbor cells is to prepare handover among the cells. The synchronization with the 6 neighbor cells is performed by acquiring and decoding an FCB and an SB of the cells listed on the BA list in a priority order of cells' signal strengths. In order to maintain the synchronizations, the mobile terminal decodes the entire BCH data every 30 seconds to a serving cell and decodes the BCCH data blocks of the BCCH carriers every 5 minutes to the 6 neighbor cells. Also, when a new BCCH carrier is detected, the mobile terminal should decode the BCCH data within 30 seconds and, otherwise, discards the BCCH data.

Also, the mobile terminal updates synchronizations to the BCCHs of the 6 neighbor cells at least every 30 seconds. When failing synchronization with a neighbor cell, the mobile terminal tries to acquire synchronization with the neighbor cell while decoding the BCH (FCB/SB) information. In the case that the mobile terminal is being served by a base station, the mobile terminal sends a measurement report containing measurement information on the serving cell and 6 neighbor cells through a Stand Alone Control Channel (SACC) periodically. In a case of Wideband Code Division Multiple Access (WCDMA) system, the mobile terminal extracts a Monitored cell list from the SI transmitted by the network and manages the neighbor cells listed on the Monitored cell list.

In the conventional cell management method, however, the mobile terminal manages the neighbor cells without consideration of channel environments, i.e. a single synchronization scheme is adopted regardless of whether the signal's electric field is good or poor and whether the mobile terminal is on the move or not, thereby causing various management inefficiencies including a waste of power. In more detail, when the mobile terminal stays for a while at a location in which the signal's electric field is good, there is little chance that a handover occurs. Accordingly, there is room for improving power control efficiency and preventing the mobile terminal from wasting power by enhancing the cell management mechanism.

### SUMMARY OF THE INVENTION

An aspect of the present invention is to address at least the above-mentioned problems and/or disadvantages and is to provide at least the advantages described below. Accordingly, an aspect of the present invention is to provide a cell management method and apparatus for a mobile terminal that is capable of improving power control efficiency and preventing a waste of power.

In accordance with an aspect of the present invention, a neighbor cell management method for a mobile terminal is provided. The method includes determining a number of cell changes in a first interval as counted by a first timer, determining a received signal strength of a current serving cell, determining a mobility of the mobile terminal and electric field status based on the number of cell changes and the received signal strength, and adjusting a number of neighbor cells listed on a neighbor cell list according to the mobility and electric field status in a lowest signal strength first order.

In accordance with another aspect of the present invention, the neighbor cell management method further includes measuring the received signal strength of the service cell periodically and determining whether a received signal spike is detected by starting a second timer when the received signal is equal to or less than the threshold signal strength, re-measuring the received signal strength of the serving cell, determining whether the re-measured received signal strength is greater than the threshold signal strength, determining, when the re-measured received signal strength is greater than the threshold signal strength, whether the second timer has expired, updating a count of received signal spikes by incrementing the count by one when the second timer has expired and by adding a preset value to the count when the second timer has not expired, and storing the updated count of the received signal spikes.

In accordance with another aspect of the present invention, a neighbor cell management apparatus for a mobile terminal is provided. The apparatus includes a radio frequency unit for receiving a signal from a network and a control unit for determining, when a first timer which starts with registration with the network expires, a number of cell changes and received signal strength of a serving cell, for determining a mobility of the mobile terminal and electric field status based on the number of cell changes and received signal strength, and for adjusting a preset number of neighbor cell listed on a neighbor cell list according to the mobility and electric field status.

In accordance with another aspect of the present invention, the neighbor cell management apparatus further includes a storage unit for storing the count of received signal strengths, and the control unit for measuring the received signal strength of the serving cell periodically, for starting a second timer when the received signal is equal to or less than the threshold signal strength, for re-measuring the received signal strength of the serving cell, for determining whether the re-measured received signal strength is greater than the threshold signal strength, for determining, when the re-measured received signal strength is greater than the threshold signal strength, whether the second timer has expired, and for updating a count of received signal spikes by incrementing the count by one when the second timer has expired and by adding a preset value to the count when the second timer has not expired.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a configuration of a mobile terminal according to an exemplary embodiment of the present invention;

FIGS. 2A, 2B, and 2C are flowcharts illustrating a neighbor cell management method according to an exemplary embodiment of the present invention; and

FIG. 3 is a flowchart illustrating an exemplary Received Signal Strength Indication (RSSI) spike checking operation of a neighbor cell management procedure of FIGS. 2B and 2C.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

FIG. 1 is a diagram illustrating a configuration of a mobile terminal according to an exemplary embodiment of the present invention.

Referring to FIG. 1, the mobile terminal includes a Radio Frequency (RF) unit 110, an audio processing unit 120, a Micro Processing Unit (MPU) 130, an input unit 140, a display unit 150, and a storage unit 160. The RF unit 110 is responsible for radio communication of the mobile terminal. The RF unit 110 includes an RF transmitter (not shown) for up-converting and amplifying transmission signal frequency and an RF receiver (not shown) for low noise amplifying and down-converting received signal frequency. The RF unit 110 outputs information carried by radio signal to the MPU 130. The information includes data received through a traffic channel and paging and other signals received through a control channel. More particularly in this exemplary embodiment, the RF unit 110 receives user data and signaling data from neighbor cells and a service cell through a Traffic Channel (TCH), a Common Control Channel (CCCH), a BCH, a Dedicated Control Channel (DCCH), an Associated Control Channel (ACCH) and the like. The audio processing unit 120 processes audio signals input through a microphone and outputs audio signals through a speaker. The audio processing unit 120 converts digital audio data received from the MPU 130 to an analog audio signal so as to be output through the speaker in the form of audible sound waves, and converts audio signals input through the microphone to digital data and outputs the digital data to the MPU 130.

The MPU 130 controls general operations of the mobile terminal. For example, the MPU 130 controls processing of the voice and data communications. The MPU 130 includes a transmitter (not shown) for encoding and modulating transmission signals and a receiver (not shown) for demodulating and decoding the received signals. For this purpose, the MPU 130 includes a modem and a codec. More particularly in this exemplary embodiment, the MPU 130 determines a mobility level of the mobile terminal based on a number of cell reselections performed during a preset time in an idle state and/or a number of handovers that occur while being in service and adjusts a number neighbor cells to be managed according to the mobility level. The MPU 130 also determines the signal electric field based on the received signal strength when the mobile terminal does not move. If the signal electric field is poor, the MPU 130 decreases the number of neighbor cells to be managed. Otherwise, if the signal electric field is good, the MPU 130 increases the number of neighbor cells to be managed.

The input unit 140 is provided with a plurality of alphanumeric keys for inputting alphanumeric data and a plurality of function keys for configuring various functions of the mobile terminal. The display unit 150 displays an operational status of the mobile terminal, menu screens, applications, playback contents, and data input and output screens. The display unit 150 may be implemented with a Liquid Crystal Display (LCD). In this case, the display unit 150 includes an LCD controller, a video memory, and LCD devices. When the LCD supports touch screen functionality, the display unit 150 may act as a part of the input unit 140.

The storage unit 160 includes a program memory and a data memory. The program memory may store application programs associated with the functions provided by the mobile terminal, and the data memory may store application data generated by the application programs and user data input by a user. More particularly in this exemplary embodiment, the storage unit 160 may store parameters associated with the neighbor cell management and variation of the received signal strength.

When power turns on, the mobile terminal scans RF channels acquired through the FCH and measures the signal strength of each RF channel for selecting a serving cell. These measurements are sorted in an order of signal strengths, and the mobile terminal acquires synchronization with a cell having the highest signal strength first through SCHs and then determines whether to camp on the cell with reference to the SI of the corresponding cell. If the cell is available, the mobile terminal camps on the cell. In the meantime, even when the mobile terminal is in an idle state, a variation may occur within a cell or among the cell due to the mobility of the mobile terminal. Accordingly, a cell reselection is required. When reception of service from the serving cell begins to fail, the mobile terminal measures received signal strengths of the neighbor cells to reselect another cell. The mobile terminal determines whether the received signal strengths of the neighbor cells are greater than a threshold value and selects a cell of which received signal strength is greater than the threshold value to camp on. Upon camping on the cell, the mobile terminal enters a dedicated mode to receive a paging signal and creates a Near cell list in which a maximum of about 32 nearby cells may be registered. A maximum about 32 Near cell list may be obtained from the SI. The mobile terminal selects cells to maintain synchronization therewith from the Near cell list. In this exemplary embodiment, the mobile terminal controls the number of cells to be managed based on the mobility and an electric field status for minimizing a waste of power. Although the neighbor cell management method is described with reference to GSM to simplify the explanation in this exemplary embodiment, the present invention is not limited thereto. For example, the neighbor cell management method may be applied to any wireless communication system that manages the neighbor cells for handover. A mobility and electric field measurement procedure of an exemplary neighbor cell management method is described in more detail hereinafter.

The mobility and electric field status may be measured in an idle mode and a dedicated mode.

In a case of idle mode measurement, the mobile terminal first determines whether a User Equipment (UE) idle mode count (UE_Count_Idle), which indicates a number of Cell Re-selections that occur in a preset idle mode time (UE_Timer_Idle), is greater than a threshold value (UE_Thres_Idle). This condition is called “Idle_Mobility condition” hereinafter. The cell reselection procedure may be triggered by a radio channel breakage, traffic overload, a user’ request, and the like. If the UE_Count_Idle is greater than the UE_Thres_Idle, the mobile terminal determines that it is on the move (i.e. Idle_Mobility condition is satisfied), and sets a Mobility Indication flag (Mobility_Ind) to True.

Meanwhile, when the signal strength of the serving cell satisfies the Idle_Mobility condition during the UE_Timer_Idle, the mobile terminal determines whether a Received Signal Strength Indication (RSSI), i.e. UE_RSSI_I is greater than an RSSI threshold (UE_Thres_RSSI_I). This is called “Idle_RSSI condition. If the UE_RSSI_I is greater than UE_Thres_RSSI_I, the mobile terminal determines that the signal electric field is good at the current location, and sets a cell environment flag (Good_Cell_Ind) flag to True. This is the case that the Idle_RSSI condition is satisfied.

Also, if the signal strength of the serving cell satisfies the Idle_RSSI condition in the UE_Timer_Idle, i.e. the UE_Count_Idle is greater than UE_Thresh_Idle and the UE_RSSI_I is greater than the UE_Thres_RSSI_I, then the mobile terminal determines whether an abrupt RSSI change is detected. That is, the mobile terminal determines whether the RSSI drops below the UE_Thres_RSSI_I and then rises above the UE_Thres_RSSI_I within a certain duration (UE_RSSI_Vary_Timer). If the RSSI falls below and rises above the RSSI threshold in this manner, the mobile terminal increments an RSSI variation count (UE_RSSI_Vary_Count_I) and, if the UE_RSSI_Vary_Count_I is greater than the threshold (UE_RSSI_Vary_Thres_I), then the mobile terminal regards that the signal strength variation is great.

In a case of communication mode (dedicated mode) measurement, the mobile terminal determines whether a handover count (UE_Count_Dedi), which indicates a number of handovers that occur in a certain time (UE_Timer_Dedi), is greater than a threshold (UE_Thres_Dedi). This condition is called “Active Mobility condition” hereinafter. The handover occurs, when the mobile terminal receiving a service from the serving cell moves to a neighbor cell, to maintain the service. If the UE_Count_Dedi is greater than UE_Thres_Dedi, the mobile terminal determines that it is on the move (i.e. Active_Mobility condition is satisfied) and sets a mobility indication flag (Mobility_Ind_Flag) to True.

When the signal strength of the serving cell satisfies the Active_Mobility condition, the mobile terminal determines whether the RSSI (UE_RSSI_D) is greater than an RSSI threshold (UE_Thres_RSSI_D) in a preset time “UE_Timer_Dedi.” This condition is called “Active_RSSI condition” hereinafter. If the UE_RSSI_D is greater than the UE_Thres_RSSI_D, than the mobile terminal determines that the signal electric field is good (i.e. the Active_RSSI condition is satisfied) and sets the cell environment flag (Good_Cell_Ind flag) to True.

When the signal strength of the serving cell satisfies the Active_RSSI condition in the UE_Timer_Dedi, (i.e. the UE_Count_Dedi is greater than the UE_Thresh_Dedi and the UE_RSSI_D is greater than UE_Thres_RSSI_D), the mobile terminal determines whether an abrupt RSSI change is detected. That is, the mobile terminal determines whether the RSSI drops below the UE_Thres_RSSI_I and then rises above the UE_Thres_RSSI_I within a preset time (UE_RSSI_Vary_Timer_D). If the RSSI falls and rises abruptly in such manner, the mobile terminal increments the UE_RSSI_Vary_Count_D, and if the UE_RSSI_Vary_Count_D is greater than the RSSI threshold (UE_RSSI_Vary_Thres_D), then the signal strength variation is abrupt. Table 1 illustrates the above-described parameters.

TABLE 1

| Parameter | Description | Value |
|---|---|---|
| UE_Timer_Idle | An interval for counting cell | Changing by |
| | reselections and detecting RSSI | 30 seconds |
| | drop below RSSI threshold in an | with no limit |
| | idle mode | |
| UE_Count_Idle | A parameter indicating a number | Changing by 1 |
| | of cell reselections counted | with no limit |
| | within the UE_Timer_Idle | |
| UE_Tresh_Idle | A threshold value of the | Changing by 1 |
| | UE_Count_Idle for determining | with no limit |
| | mobility of the UE | |
| Mobility_Ind | A parameter indicating whether | True, False |
| | the UE is on the move. True | |
| | indicates that the UE is on the | |
| | move, and False indicates that the | |
| | UE is not on the move. | |
| Good_Cell_Ind | A parameter indicating that the | True, False |
| | UE in a good cell. True indicates | |
| | the UE is in a good cell, and False | |
| | indicates the UE is in a bad cell. | |
| UE_Timer_Dedi | An interval for counting | Changing by |
| | handovers and detecting RSSI | 10 seconds |
| | drop below RSSI threshold in a | with no limit |
| | dedicated mode | |
| UE_Count_Dedi | A parameter indicating a number | Changing by 1 |
| | of handovers within the | with no limit |
| | UE_Timer_Dedi. | |
| UE_Thres_Dedi | A threshold value of the | Changing by 1 |
| | UE_Count_Dedi for determining | with no limit |
| | mobility of the UE. | |
| UE_Thres_RSSI_I | An RSSI threshold for | −50~−110 dBm |
| | determining whether an idle | |
| | mode UE is in a good cell. | |
| UE_RSSI_Vary_Count_I | A parameter indicating a number | Integer |
| | of drops of the RSSI below | changing by 1 |
| | UE_Thres_RSSI_I. This | with no limit |
| | parameter increases by 1 when | |
| | the RSSI dropped below | |
| | UE_Thres_RSSI_I rises over | |
| | UE_Thres_RSSI_I | |
| UE_RSSI_Vary_Thres_I | A UE_RSSI_Vary_Count_I | Integer |
| | threshold for determining whether | changing by 1 |
| | the signal electric field is poor. | with no limit |
| UE_RSSI_Vary_Timer_I | An interval for tolerating that the | 0.1 up to 5 |
| | RSSI dropped below the | seconds |
| | UE_Thres_RSSI_I rises over | |
| | UE_Thres_RSSI_I in an idle | |
| | mode | |
| UE_Thres_RSSI_D | An RSSI threshold for | −50~−110 dBm |
| | determining whether a dedicated | |
| | mode UE is in a good cell. | |
| UE_RSSI_Vary_Count_D | A parameter indicating a number | Integer |
| | of drops of the RSSI below | changing by 1 |
| | UE_Thres_RSSI_D. This | with no limit |
| | parameter increases by 1 when | |
| | the RSSI dropped below | |
| | UE_Thres_RSSI_D rises over | |
| | UE_Thres_RSSI_D | |
| UE_RSSI_Vary_Thres_D | A UE_RSSI_Vary_Count_D | Integer |
| | threshold for determining whether | changing by 1 |
| | the signal electric field is poor. | with no limit |
| UE_RSSI_Vary_Timer_D | An interval for tolerating that the | 0.1 up to 5 seconds |
| | RSSI dropped below the | |
| | UE_Thres_RSSI_D rises over | |
| | UE_Thres_RSSI_D in a | |
| | dedicated mode | |

With reference to these conditions, the mobile terminal determines its mobility and electric field status and adjusts the number of cells to be managed on the basis of the mobility and electric field status.

If the mobile terminal is in an idle mode and not on the move, i.e. the mobile node does not move or moves at an ignorable speed, then it removes a number of neighbor cells less than or equal to an idle mode negative-mobility removal number (N_Idle_Cell) from the neighbor cell list registering a number of the neighbor cells less than or equal to an original neighbor cell number (Orig_I_NCell) in a lowest RSSI-first-remove order. After removing the idle mode negative-mobility removal number of neighbor cells, the mobile terminal determines whether the current signal electric field is good. If the current signal electric field is good, then the mobile terminal removes a number of neighbor cells less than or equal to an idle mode positive-electric field removal number (N_Idle_RSSI) from the neighbor cell list additionally in the lowest RSSI-first-remove order.

When the mobile terminal is on the move, the aforementioned cell removal algorithm is disabled such that the mobile terminal manages the neighbor cell list with the original neighbor cell number (Orig_I_NCell). In this exemplary embodiment, the Orig_I_NCell is set to six (6) as specified in GSM.

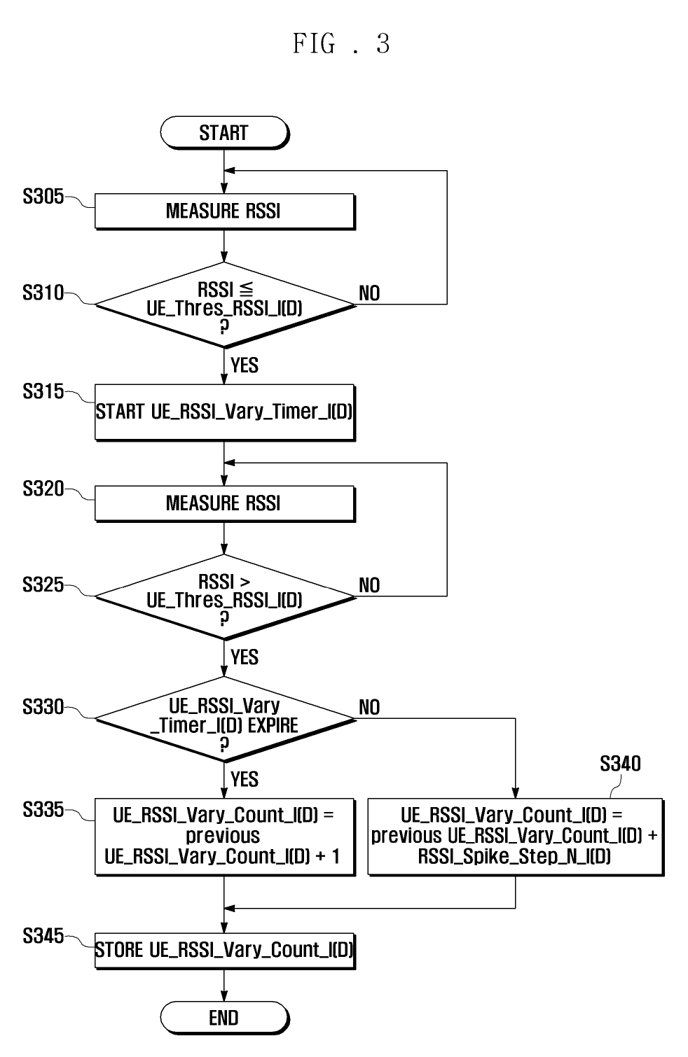

In the meantime, the quality of signal electric field may be determined in consideration of another condition, i.e. RSSI spike. The mobile terminal monitors to detect the occurrence of a relatively large RSSI spike. If a large RSSI spike is detected in a preset time, the mobile terminal increases the UE_RSSI_Vary_Count_D as much as a preset value. This is described in more detail with reference to FIG. 3.

In a dedicated mode, if the mobility is zero or low enough to ignore, then the mobile terminal removes a number of the neighbor cells less than equal to a dedicated mode negative-mobility removal number (N_Dedi_Ncell), which is a preset number of cells to be removed when the mobility is low enough to ignore in the dedicated mode, from the Orig_D_Ncell in the lowest RSSI-first-remove order. After removing the dedicated mode negative-mobility removal number (N_Dedi_Ncell), the mobile terminal determines whether the current signal electric field is good. If the current signal electric field is good, then the mobile terminal removes a number of neighbor cells less than or equal to a dedicated mode positive-electric field removal number (N_Dedi_RSSI) from the neighbor cell list additionally in the lowest RSSI-first-remove order.

When the mobile terminal is on the move, the aforementioned cell removal algorithm is disabled such that the mobile terminal manages the neighbor cell list with the Orig_I_Ncell. In this exemplary embodiment, the Orig_I_NCell is set to six (6) as specified in GSM.

In the meantime, the quality of signal electric field may be determined in consideration of another condition, i.e. RSSI spike. The mobile terminal monitors to detect the occurrence of a relatively large RSSI spike. If a large RSSI spike is detected in a preset time, the mobile terminal increases the UE_RSSI_Vary_Count_D by a preset value. This is described in more detail with reference to FIG. 3. Table 2 illustrates the aforementioned parameters.

TABLE 2

| Parameter | Description | Value |
|---|---|---|
| Orig_I_NCell | An original number of | Decrementing by 1 |
| | neighbor cells managed in an | (GSM 3GPP: 6) |
| | idle mode. | |
| I_NCell | A reduced number of neighbor | Decrementing by 1 |
| | cells remained after adopting a | (GSM 3GPP: 6) |
| | cell number management | |
| | algorithm in an idle mode. | |
| N_Idle_NCell | A number of cells to be | Integer decrementing by |
| | reduced when the idle mode | 1 with no limit (integer) |
| | UE is not on the move. | |
| N_Idle_RSSI | A number of cells to be | Integer decrementing by |
| | reduced when the idle mode | 1 with no limit (integer) |
| | UE is in a good cell. | |
| Orig_DNCell | An original number of | Decrementing by 1 with |
| | neighbor cells managed in a | no limit (GSM 3GPP: 6) |
| | dedicated mode. | |
| D_NCell | A reduced number of cells after | Decrementing by 1 with |
| | adopting a cell number | no limit |
| | management algorithm in a | |
| | dedicated mode. | |
| N_Dedi_NCell | A number of cells to be | Integer decrementing by |
| | reduced when the dedicated | 1 with no limit |
| | mode UE is on the move. | |
| N_Dedi_RSSI | A number of cells to be | Integer decrementing by |
| | reduced when the dedicated | 1 with no limit |
| | mode UE is in a good cell. | |
| N_RSSI_Cell_I | A number of cells to be | Integer decrementing by |
| | reduced when the idle mode is | 1 with no limit |
| | in a good cell. | |
| N_RSSI_Cell_D | A number of cells to be | Integer decrementing by |
| | reduced when the active UE is | 1 with no limit |
| | in a good cell. | |
| RSSI_Spike_Step_N_I | A number of cells to be | Integer decrementing by |
| | reduced when the idle UE | 1 with no limit |
| | detects RSSI spike. | |
| RSSI_Spike_Step_N_D | A number of cells to be | Integer decrementing by |
| | reduced when the active UE | 1 with no limit |
| | detects RSSI spike. | |

An exemplary neighbor cell management method is described hereinafter with reference to drawings.

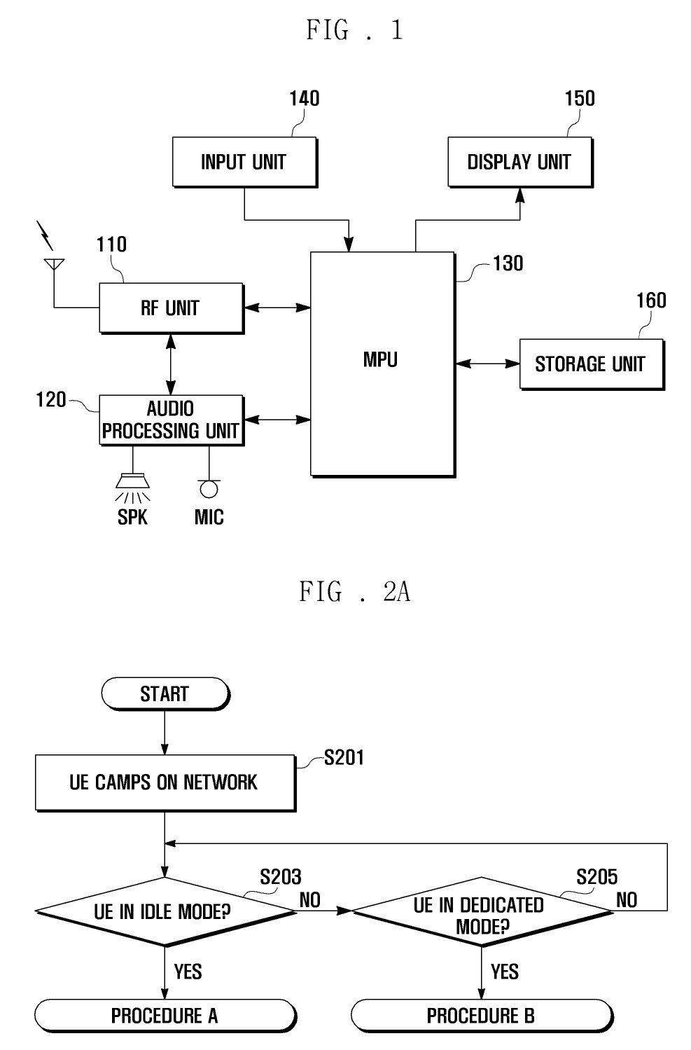

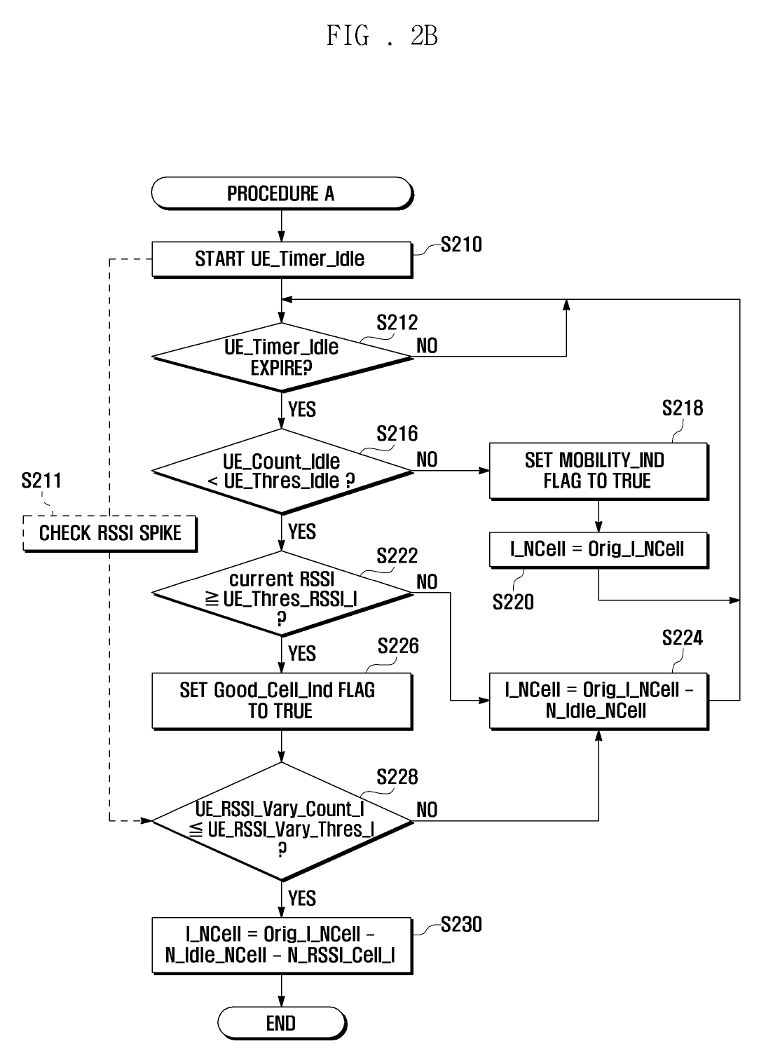

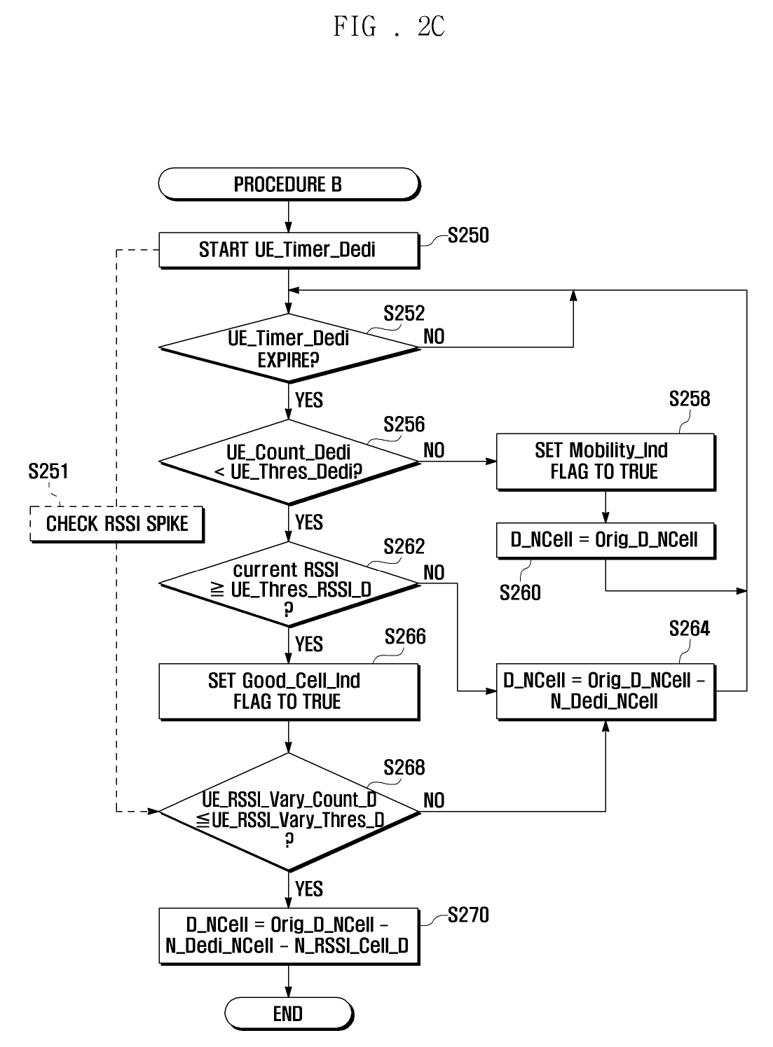

FIGS. 2A, 2B, and 2C are flowcharts illustrating a neighbor cell management method according to an exemplary embodiment of the present invention.

Referring to FIG. 2A, the MPU 130 of a User Equipment (UE) searches for a serving cell and camps on the serving cell in step S201. Accordingly, the UE is registered with the network. Next, the MPU 130 determines whether the UE is in an idle mode in step S203. If the UE is in the idle mode, then the MPU 130 performs a procedure A of FIG. 2B. Otherwise, if the UE is not the idle mode, the MPU 130 determines whether the UE is in a dedicated mode in step S205. If the UE is in the dedicated mode, the MPU 130 performs a procedure B of FIG. 2C and, otherwise, returns to step S203.

Referring to FIG. 2B, if it is determined that the UE is in the idle mode at step S203 of FIG. 2A, then the MPU 130 starts a timer “UE_Timer_Idle” in step S210 and monitors to detect the occurrence of an RSSI spike simultaneously in step S211. The RSSI spike detection is performed for detecting abrupt RSSI variation. After the UE camps on the cell, the MPU 130 measures the RSSI periodically and counts a number of RSSI spikes (UE_RSSI_Vary_Count_I). The UE_RSSI_Vary_Count_I is used at step S228. After starting the UE_Timer_Idle, the MPU 130 waits until the UE_Timer_Idle expires in step S212. If the UE_Timer_Idle expires, then the MPU 130 determines whether the UE_Count_Idle is less than the UE_Thresh_Idle in step S216. If the UE_Count_Idle is less than UE_Thresh_Idle, then the MPU 130 proceeds to step S222 and, otherwise, proceeds to step S218. If the UE_Count_Idle is less than UE_Thresh_Idle, then the MPU 130 determines that the UE is not on the move, otherwise, the MPU 130 determines that the UE is on the move. The MPU 130 sets the Mobility_Ind_flag to True at step S218, maintains the Orig_I_Ncell in step S220, and returns to step S212. Although the neighbor cell management method according to this exemplary embodiment is described under the assumption that the initial value of the Mobility_Ind_flag is False, the initial value may be changed depending on the hardware configuration.

At step S222, the MPU 130 determines whether the current RSSI is equal to or greater than the UE_Thres_RSSI_I. If the current RSSI is equal to or greater than the UE_Thres_RSSI_I, then the MPU 130 sets the Good_Cell_Ind flag to True in step S226. Otherwise, if the current RSSI is less than the UE_Thres_RSSI_I, then the MPU 130 removes a number of neighbor cells less than or equal to N_Idle_NCell from a number of neighbor cells less than or equal to Orig_I_NCell on the neighbor cell list (I_NCell) in step S224 and returns to step S212. Accordingly, the UE which is not on the move manages a relatively small number of neighbor cells in comparison with the UE which is on the move. In the meantime, after setting the Good_Cell_Ind flag to True at step S226, the MPU 130 determines whether the UE_RSSI_Vary_Count_I is equal to or less than the UE_RSSI_Vary_Thres_I in step S228. Although the neighbor cell management method according to this exemplary embodiment is described under the assumption that the initial value of the Good_Cell_Ind_flag is False, the initial value may be changed depending on the hard configuration.

If the US_RSSI_Vary_Count_I is equal to or less than the UE_RSSI_Vary_Thres_I, then the MPU 130 proceeds to step S230 and, otherwise, returns to step S224. The UE_RSSI_Vary_Count_I equal to or less than the UE_RSSI_Vary_Thres_I indicates that the RSSI is stable without abrupt change. Otherwise, the UE_RSSI_Vary_Count_I greater than the UE_RSSI_Vary_Thres_I indicates that the RSSI is unstable so as to abruptly change. The MPU 130 removes a number of neighbor cells less than or equal to the number obtained by summing the N_Idle_NCell and N_RSSI_Cell_I from a number of neighbor cells less than or equal to Orig_I_NCell on the neighbor cells list (I_NCell). Here, the N_Idle_Cell and N_RSSI_Cell_I may be set by the user. In this manner, the UE which is not on the move in good signal electric field may reduce the number of neighbor cells to be managed, thereby reducing power consumption caused by managing unnecessary neighbor cells, resulting in more efficient neighbor cell management.

Referring to FIG. 2C, if it is determined that the UE is in the dedicated mode at step S205, then the MPU 130 starts a timer “UE_Timer_Dedi” in step S250 and monitors to detect an occurrence of an RSSI spike simultaneously in step S251. The RSSI spike detection is performed for detecting abrupt RSSI variation. After the UE camps on the cell, the MPU 130 measures the RSSI periodically and counts a number of RSSI spikes (UE_RSSI_Vary_Count_D). The UE_RSSI_Vary_Count_D is used at step S268. After starting the UE_Timer_Dedi, the MPU 130 waits until the UE_Timer_Idle expires in step S252. If the UE_Timer_Dedi expires, then the MPU 130 determines whether the UE_Count_Dedi is less than the UE_Thresh_Dedi in step S256. If the UE_Count_Dedi is less than UE_Thresh_Dedi, then the MPU 130 proceeds to step S262 and, otherwise, proceeds to step S258. If the UE_Count_Dedi is less than UE_Thresh_Dedi at step S256, then the MPU 130 determines that the UE is not on the move, otherwise, the MPU 130 determines that the UE is on the move. The MPU 130 sets the Mobility_Ind_flag to True at step S258, maintains the Orig_D_Ncell in step S260, and returns to step S252. Although the neighbor cell management method according to this exemplary embodiment is described under the assumption that the initial value of the Mobility_Ind_flag is False, the initial value may be changed depending on the hardware configuration.

At step S262, the MPU 130 determines whether the current RSSI is equal to or greater than the UE_Thres_RSSI_D. If the current RSSI is equal to or greater than the UE_Thres_RSSI_D, then the MPU 130 sets the Good_Cell_Ind flag to True in step S266. Otherwise, if the current RSSI is less than the UE_Thres_RSSI_D, then the MPU 130 removes a number of neighbor cells less than or equal to N_Dedi_NCell from a number of neighbor cells less than or equal to Orig_D_NCell on the neighbor cell list (D_NCell) in step S264 and returns to step S252. Accordingly, the UE which is not on the move manages a relatively small number of neighbor cells in comparison with the UE which is on the move. In the meantime, after setting the Good_Cell_Ind flag to True at step S266, the MPU 130 determines whether the UE_RSSI_Vary_Count_D is equal to or less than the UE_RSSI_Vary_Thres_D in step S268. Although the neighbor cell management method according to this exemplary embodiment is described under the assumption that the initial value of the Good_Cell_Ind_flag is False, the initial value may be changed depending on the hard configuration.

In step S268, if the UE_RSSI_Vary_Count_D is equal to or less than the UE_RSSI_Vary_Thres_D, then the MPU 130 proceeds to step S270 and, otherwise, step S264. The UE_RSSI_Vary_Count_D which is equal to or less than the UE_RSSI_Vary_Thres_D indicates that the RSSI is stable without abrupt change. Otherwise, the UE_RSSI_Vary_Count_D which is greater than the UE_RSSI_Vary_Thres_D indicates that the RSSI is unstable so as to abruptly change. The MPU 130 removes a number of neighbor cells less than or equal to the number obtained by summing the N_Dedi_NCell and N_RSSI_Cell_D from a number of neighbor cells less than or equal to Orig_D_NCell on the neighbor cells list (D_NCell) in step S270. Here, the N_Dedi_Cell and N_RSSI_Cell_D may be set by the user. In this manner, the UE, which is not on the move and which is in good signal electric field, may reduce the number of neighbor cells to be managed, thereby reducing the power consumption caused by managing unnecessary neighbor cells, resulting in efficient neighbor cell management.

The RSSI spike checking step S211 of FIG. 2B or S251 of FIG. 2C is described hereinafter with reference to FIG. 3 in more detail.

FIG. 3 is a flowchart illustrating an exemplary RSSI spike checking operation of a neighbor cell management procedure of FIGS. 2B and 2C.

Referring to FIG. 3, the MPU 130 measures the RSSI of the serving cell periodically in step S305 and determines whether the current RSSI is equal to or less than the UE_Thres_RSSI_I (or UE_Thres_RSSI_D) in step S310. If the current RSSI is equal to or less than the UE_Thres_RSSI_I (or UE_Thres_RSSI_D), then the MPU 130 proceeds to step S315 and, otherwise, returns to step S305. At step S315, the MPU 130 starts a timer UE_RSSI_Vary_Timer_I (or UE_RSSI_Vary_Timer_D) for checking an abrupt RSSI variation. Next, the MPU 130 measures the RSSI in step S320 and determines whether the current RSSI is greater than the UE_Thres_RSSI_I (or UE_Thres_RSSI_D) in step S325. If the measured RSSI is greater than the UE_Thres_RSSI_I (or UE_Thres_RSSI_D), the MPU 130 proceeds to step S330 and, otherwise, returns to step S320.

If the measured RSSI is greater than the UE_Thres_RSSI_I (or UE_Thres_RSSI_D) in step S325, then the MPU 130 determines whether the UE_RSSI_Vary_Timer_I (or UE_RSSI_Vary_Timer_D) expires in step S330. If the UE_RSSI_Vary_Timer_I (or UE_RSSI_Vary_Timer_D) expires, then the MPU 130 proceeds to step S335 and, otherwise, proceeds to step S340. At step S335, the MPU 130 increments the UE_RSSI_Vary_Count_I (or UE_RSSI_Vary_Count_D) by one and checks the value of the updated UE_RSSI_Vary_Count_I (or UE_RSSI_Vary_Count_D). When there is no previously stored UE_RSSI_Vary_Count_I (or UE_RSSI_Vary_Count_D), the UE_RSSI_Vary_Count_I (or UE_RSSI_Vary_Count_D) is set to 0. In contrast, at step S340, the MPU 130 adds an addition value RSSI_Spike_Step_N_I (RSSI_Spike_Step_N_D) to the UE_RSSI_Vary_Count_I (or UE_RSSI_Vary_Count_D) and checks the value of the updated UE_RSSI_Vary_Count_I (or UE_RSSI_Vary_Count_D). Finally, the MPU 130 stores the UE_RSSI_Vary_Count_I (or UE_RSSI_Vary_Count_D) in step S345.

While the invention has been shown and described with reference to certain exemplary embodiments thereof, it will be understood by those skilled in the art that various changes in forms and detail may be made therein without departing from the spirit and scope of the invention as defined by the appended claims and their equivalents.

What is claimed is:

1. A neighbor cell management method for a mobile terminal, the method comprising:
determining a number of cell changes in a first interval as counted by a first timer;
determining a received signal strength of a current serving cell;
determining a mobility of the mobile terminal and an electric field status based on the number of cell changes and the received signal strength; and
adjusting a preset number of neighbor cells listed on a neighbor cell list according to the mobility and electric field status.

2. The method of claim 1, wherein the determining of the mobility of the mobile terminal comprises comparing the number of cell changes with a threshold cell reselection count.

3. The method of claim 2, wherein the determining of the electric field status comprises:
comparing the received signal strength with a threshold signal strength; and
determining whether a received signal spike is detected in a time period.

4. The method of claim 3, wherein the determining of the mobility and the electric field status comprises:
determining a non-mobility of the mobile terminal if the number of the cell changes is less than the threshold cell reselection count: and
determining a good electric field status if the received signal strength is greater than the threshold signal strength, and no received signal spike is detected.

5. The method of claim 1, further comprising starting the first timer when the mobile terminal registers with a network.

6. The method of claim 1, wherein the number of cell changes comprises a number of cell reselections when the mobile terminal is in an idle state and a number of handovers when the mobile terminal is in a dedicated state.

7. The method of claim 1, wherein the adjusting of the preset number of neighbor cells comprises:
maintaining, when the mobile terminal is on the move, the number of neighbor cells listed on the neighbor cell list: and
removing a preset number of neighbor cells from the neighbor cell list in an order of signal strength according to the electric field status in a state in which the mobile terminal is in a non-mobility.

8. The method of claim 1, further comprising measuring the received signal strength of the service cell periodically.

9. The method of claim 3, wherein the determining of whether the received signal spike is detected comprises:
starting a second timer when the received signal is equal to or less than the threshold signal strength;
re-measuring the received signal strength of the serving cell;
determining whether the re-measured received signal strength is greater than the threshold signal strength;
determining, when the re-measured received signal strength is greater than the threshold signal strength, whether the second timer has expired;
updating a count of received signal spikes by incrementing the count by one when the second timer has expired and by adding a preset value to the count when the second timer has not expired; and
storing the updated count of the received signal spikes.

10. The method of claim 9, wherein the received signal spike does not occur when the re-measured received signal strength is equal to or less than the threshold signal strength.

11. A neighbor cell management apparatus for a mobile terminal, the apparatus comprising:
a radio frequency unit for receiving a signal from a network; and
a control unit for determining, when a first timer which starts with registration with the network expires, a number of cell changes, for determining a received signal strength of a serving cell, for determining a mobility of the mobile terminal and electric field status based on the number of cell changes and the received signal strength, and for adjusting a preset number of neighbor cells listed on a neighbor cell list according to the mobility and electric field status.

12. The apparatus of claim 11, wherein the control unit determines a mobility of the mobile terminal by comparing the number of cell changes with a threshold cell reselection count.

13. The apparatus of claim 12, wherein the control unit determines the electric field status by comparing the received signal strength with a threshold signal strength, and determines whether a received signal spike is detected in a time period.

14. The apparatus of claim 13, wherein the control unit determines a non-mobility if the number of the cell changes is less than the threshold cell reselection count, and determines a good field status if the received signal strength is greater than the threshold signal strength, and no received signal spike is detected.

15. The apparatus of claim 11, wherein the number of cell changes comprises a number of cell reselections when the mobile terminal is in an idle state and a number of handovers when the mobile terminal is in a dedicated state.

16. The apparatus of claim 11, wherein the control unit maintains, when the mobile terminal is on the move, the number of neighbor cells listed on the neighbor cell list, and removes a preset number of neighbor cells from the neighbor cell list in an order of signal strength according to the electric field status in a state in which the mobile terminal is in a non-mobility.

17. The apparatus of claim 11, further comprising a storage unit for storing at least one of the number of cell changes and the strength of the received signal.

18. The apparatus of claim 17, wherein the control unit measures the received signal strength of the serving cell periodically, starts a second timer when the received signal is equal to or less than the threshold signal strength, re-measures the received signal strength of the serving cell, determines whether the re-measured received signal strength is greater than the threshold signal strength, determines, when the re-measured received signal strength is greater than the threshold signal strength, whether the second timer has expired, and updates a count of received signal spikes by incrementing the count by one when the second timer has expired and by adding a preset value to the count when the second timer has not expired.

19. The apparatus of claim 18, wherein the control unit determines that the received signal spike does not occur when the re-measured received signal strength is equal to or less than the threshold signal strength.
